(19) United States
(12) Patent Application Publication
(10) Pub. No.: US 2006/0026267 A1
(43) Pub. Date: Feb. 2, 2006

(54) Method, system, and cluster for the update of management objects

(76) Inventors: Andre Godin, Laval (CA); Soumendra Daas, San Diego, CA (US); Prakash Surendranadhan, San Diego, CA (US)

Correspondence Address: Ericsson Canada Inc.;Patent Department, 8400 Decarie Blvd., Town Mount Royal, QC, H4P 2N2, CA

(21) Appl. No.: 10/903,005

(22) Filed: Aug. 2, 2004

(51) Int. Cl. G06F 15/177

(52) U.S. Cl. 709/220

(57) ABSTRACT

A method, system and cluster of Management Objects (MOs) for creating and maintaining a relationship between one or more MOs and one or more attribute values that are common to the MOs. These attribute values may be contained in one or more configuration templates, and the MOs are grouped in a cluster of MOs sharing the same attribute values, i.e. the same configuration templates. The relationship provided by the cluster between the templates and the MOs allows for a one-time definition of the persistent relationship, which reduces the subsequent edition tasks. The relation between the management objects and templates is first defined by creating the cluster with MOs and templates. Subsequent updates to the templates are propagated to the MOs of the cluster. Likewise, subsequent addition of MOs to the cluster engenders a transfer of attribute values of the cluster's templates to the added MOs.

### BACKGROUND OF THE INVENTION

1. Field of the Invention

The present invention relates to the field of management systems, and in particular to the field of virtual representations of network elements through the use of management object instances.

2. Description of the Related Art

Management systems are well known in the art. They are used for monitoring and managing the quality of communications over various networks, such as for example Local Area Networks (LANs), Wide Area Networks (WANs), Public Local Mobile Networks (PLMNs), and Public Switching Telephone Networks (PSTNs), hereinafter designated as the managed or monitored networks. Exemplary functions of a typical management system comprise, but are not limited to, providing configuration and status information about Network Elements (NEs) or NEs' components, collecting alarm/event notifications, correlating the alarm/event notifications with each other, diagnosing and repairing errors and malfunctions. In such systems, pieces of information called events (or event notifications or alarms) may be issued by the NEs of the managed network and acquired by the management system, which is responsible of their treatment. The information issued by the processing of the alarm/event notifications may be monitored, either automatically or by system administrators, with the general purpose of maintaining or increasing the quality of the communications of the managed network. On the other side, another function of the management system comprises updating configuration attributes related to the managed network's elements using a configuration user interface, and deploying the updates toward the managed network's elements.

Reference is now made to FIG. 1 (Prior Art), which is a high-level network diagram of a management system 100 which function is to manage a Public Local Mobile Network (PLMN) 102. The PLMN 102 may comprise, as it is well known in the art, a plurality of NEs, such as for example base stations 104-107, which provide cellular radio service to a plurality of mobile stations 108-119 via associated radio interfaces. The base stations 104-107 are connected to a Base Station Controller 1 (BSC 1) 120, which in turn connects to a Mobile Switching Center 1 (MSC 1) 122. The PLMN 102 may further comprise a second MSC, called MSC 2 124, and a second BSC, called BSC 2 126, as well as a Gateway GPRS Support Node (GGSN) 127, a Serving GPRS Support Node (SGSN) 128 and an associated Base Station Subsystem (BSS) 130. According to the exemplary PLMN 102 shown in FIG. 1, each NE of the managed network (the PLMN 102), comprises a management Agent (Agent 1 to Agent 7) responsible for maintaining management information about the NE that stores it. The management information of each Agent may comprise configuration and status information about the particular NE and its components and connections. Each such NE Agent connects via management links 111 (shown in double line) to a Manager 160 of the management system 100, which function is to collect events and alarm notifications 150, 152, and 154 issued by the NEs' Agents 1-7 121, 123, 125, 127, 129, 131, and 133 of the managed system 102. The Manager 160 receives the alarm and events notifications 150, 152, and 154 from the monitored system 102 and may further process, correlate, and adapts the received information into a format compatible and suitable for viewing by a variety of system administrators' terminals 162-168 of the management system 100. A further function of the Manager 160 is to allow for the updating of configuration attributes related to any one or more of the managed NEs, using the configuration management terminals 162-168, and to deploy the updated attributes to the NEs, such as shown in the exemplary actions 180, 182, 184.

In a typical management system, the management information stored in the Manager 160 comprises virtual entities known as management objects, or management object instances, which are virtual representations of the managed network's NEs and/or associated components. For example, the NE BSC 1 120 is represented in the Manager 160 as a management object.

Such a virtual representation of each NE and NE component of the managed network 102, i.e. the management objects, have configuration attributes that allow system administrators to be able to view and edit the characteristics of each such management objects. These updates are then deployed as configuration attributes to corresponding NEs in the managed network 102. In this manner, system administrators are able to monitor and improve the quality of the communications of the managed network 102.

Reference is now made to FIG. 2 (Prior Art), which shows an example of configuration management system as it is known in the prior art. First, such a configuration management system 200 comprises a configuration Management Information Base (MIB) 202 that is typically a memory or a database within the configuration management system (also designated hereinbefore “Manager”) responsible for storing the management object instances representative of NEs of the managed network. For example, the configuration MIB 202 may comprise a series of cell-type management objects 204, i.e. management objects representative of radio cells of a cellular network, wherein each such management object comprises a series of configuration attributes defining the characteristics of the MO, and by consequence of its associated NE, such as for example the configuration attributes 206 for the management object associated to the cell 204₂. The configuration MIB 202 may further comprise management objects of other types, such as for example but not limited to base station channels 208, and Base Station Controllers (BSC) 210, wherein each such management object has its own lists of attributes (not all are shown for simplicity purposes). During the normal operation of the configuration management system 200, a network administrator may supervise the operation of the managed network by monitoring the management object status of the configuration MIB 202. The network administrator may also perform updates of the configuration attributes of any management object stored in the configuration MIB 202, or even create new management objects when new NEs are to be added to the network. In such instances, the network administrator individually creates or updates one management object at a time and inputs configuration attributes for each such newly created or updated management object. However, instances arise when large numbers of management objects have to be created or updated at a time, which renders the operations long and fastidious.

A slight improvement of the prior art technique for updating or creating new management objects is the introduction of the concept of management object templates. Such templates 218 comprise a default series of configuration attributes for a given type of management object, and are stored in a template MIB 220 of the configuration management system 200. For example, in the template MIB 220, the configuration attribute template “template_cell_pc_1” 218₁ relates to a cell-type management object (a management object representing a radio cell of a base station of a cellular network), and in particular to power control (PC) configuration attributes of the cell management object, and thus comprises configuration attribute values 222 that relate to the power control of the radio cell. Thus, when the network administrator desires to create or to update a given management object that shares the default group of configuration attributes, he no longer has to manually input each attribute individually, but can rather choose the proper configuration attribute template(s) from the templates MIB 220, and apply the template(s) to the selected management object, which inherits the default power control configuration attributes of the template(s).

Reference is now made to FIG. 3 (Prior Art), which shows a high-level flowchart diagram representative of a prior art method for applying a template to a management object. In action 300, the network administrator may select the management object instance to which a template should be applied, and in action 302, the administrator selects a configuration template from the templates MIB 220. Further, in action 304, the administrator may issue a command to apply that template's configuration attribute values to the selected management object instance, and responsive to the command, the values contained in that template are transferred to the selected management object. Once this action completed, the method saves the changes made to the selected management object in the configuration MIB 202, and the method ends in action 306. No further relation is kept between the selected template and the management object.

After the management object is created and supplied with the proper configuration attributes as shown in FIG. 3, either manually or from a template, instances arise when its values must later be further updated in order to ensure the proper functioning of the network. However, with the existing prior art implementations, the entire process of updating the management object must be restarted from the beginning, because in the prior art techniques there is no persistent relationship kept between a template of the templates MIB 220 and management object(s) of the configuration MIB 202.

Accordingly, it should be readily appreciated that in order to overcome the deficiencies and shortcomings of the existing solutions, it would be advantageous to have a method and system for effectively creating or updating more than one management object at a time. It would be also of further advantage to persistently store a relationship between one or more configuration templates used for creating or updating management objects, and the management objects themselves, so that updates can be easily ad effectively propagated to the management objects. The present invention provides such a method and system.

### SUMMARY OF THE INVENTION

In one aspect, the present invention is a cluster of management objects comprising:
a list of one or more management objects; and
a reference to one or more attribute values common to the plurality of management objects.

In another aspect, the present invention is a configuration management system comprising:
a management object configuration Management Information Base (MIB) comprising a plurality of management objects; and
a cluster MIB comprising one or more clusters of management objects;
wherein each cluster of management objects comprises a reference to one or more attribute values common to one or more management objects from the plurality of management objects.

In another yet aspect, the present invention is a method for creating a cluster of management objects, the method comprising the steps of:
a. selecting one or more management objects;
b. selecting one or more configuration attribute values for the one or more management objects;
c. applying the one or more attribute values to the one or more management objects; and
d. linking the cluster containing the one or more management objects to the one or more configuration attributes values.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a high-level network diagram of a management system known in the prior art;

FIG. 2 (Prior Art) shows a high-level block diagram of an exemplary configuration management system known in the prior art;

FIG. 3 (Prior Art) is a high-level flowchart diagram representative of a prior art method for applying a management object template to a management object;

FIG. 4 is a high-level exemplary representation of a configuration management system according to the preferred embodiment of the present invention;

FIG. 5 is a high-level block diagram of the configuration management system according to the preferred embodiment of the present invention;

FIG. 6 is an exemplary representation of the configuration management Graphical User Interface (GUI) according to the preferred embodiment of the present invention;

FIG. 7 is an exemplary flowchart diagram representative of a method for creating a management object cluster according to the preferred embodiment of the present invention;

FIG. 8 is another exemplary flowchart diagram representative of a method for updating the management object cluster according to the preferred embodiment of the present invention;

FIG. 9 is yet another exemplary flowchart diagram representative another method for updating the management object cluster according to the preferred embodiment of the present invention; and

FIG. 10 is yet another exemplary flowchart diagram representative of a method for updating a configuration template according to the preferred embodiment of the present invention.

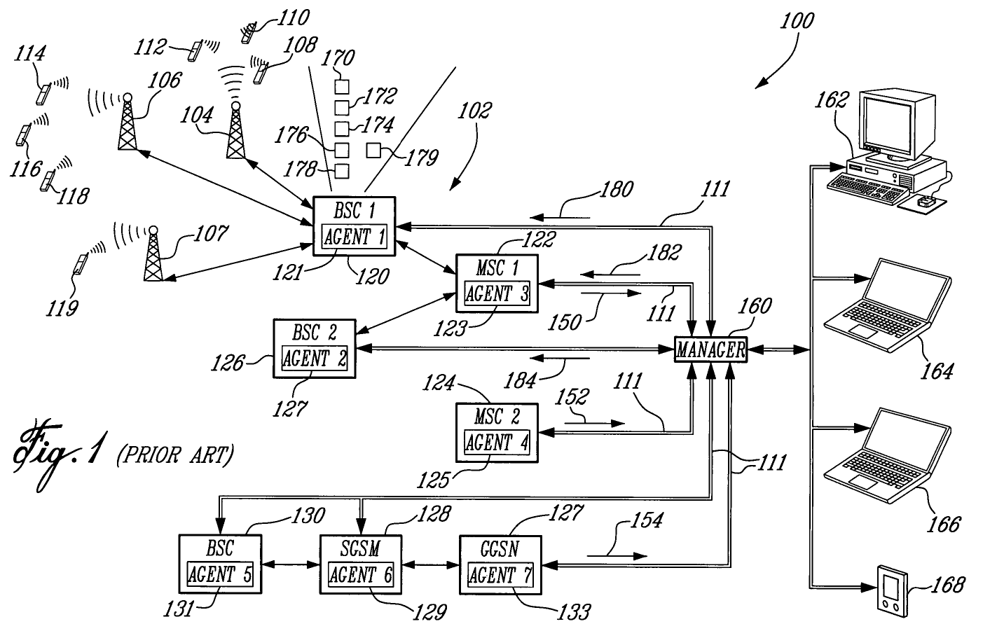

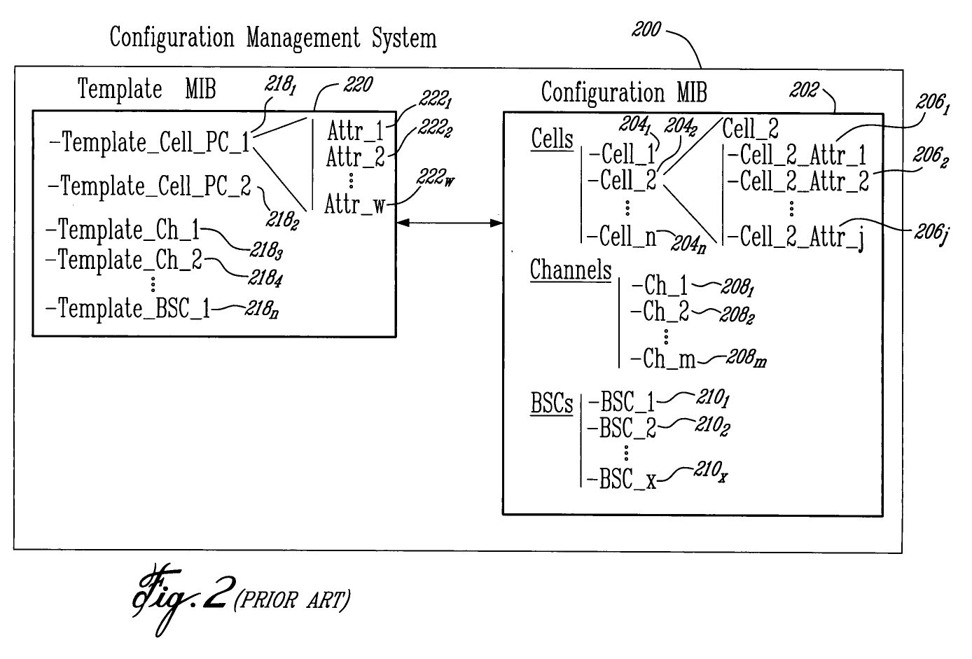

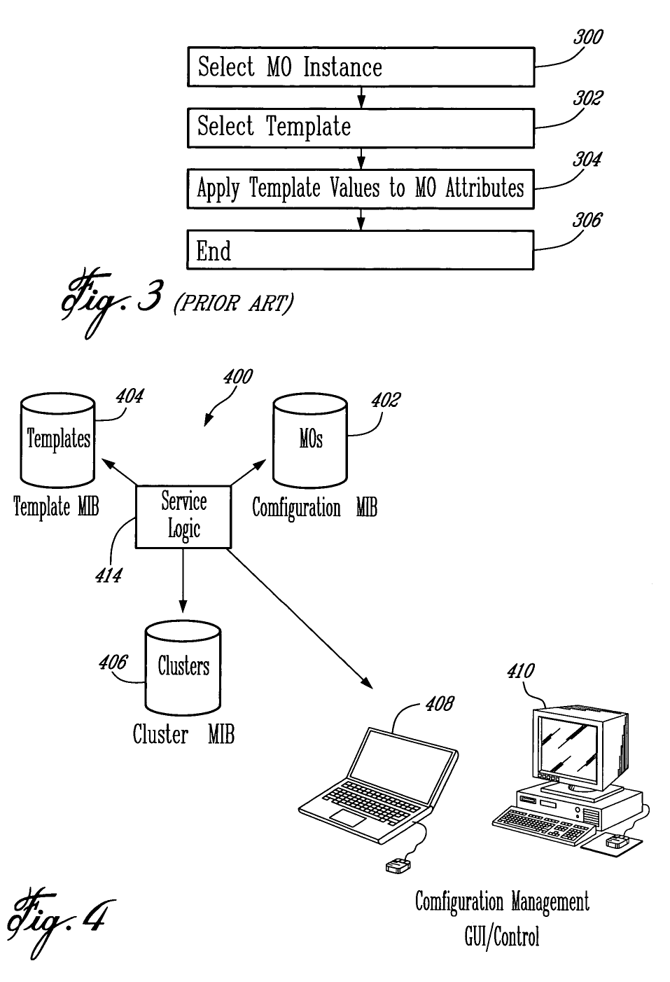

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention introduces the concept of cluster of management objects. According to the present invention, such a cluster is a group of management objects that share the same configuration attribute value(s), which may be defined in one or more management object configuration templates. The management objects that belong to a given cluster may preferably be of the same type, or at least have configuration attributes of the same type. For example, a management object cluster of a cell-type, i.e. which management objects represent radio cells of a cellular network, may comprise five different management objects representative of radio base station cells, which share the same configuration attributes values related to the cells' power control. By persistently associating a cluster of management objects with one or more configuration attributes defined in a template, the present invention allows for subsequent updates being performed directly in the templates to be automatically, i.e. without a human confirmation, or semi-automatically, i.e. with human confirmation or instruction, to be propagated to each management object that is part of the cluster, without the need for individual and manual intervention to update each attribute of such management object individually.

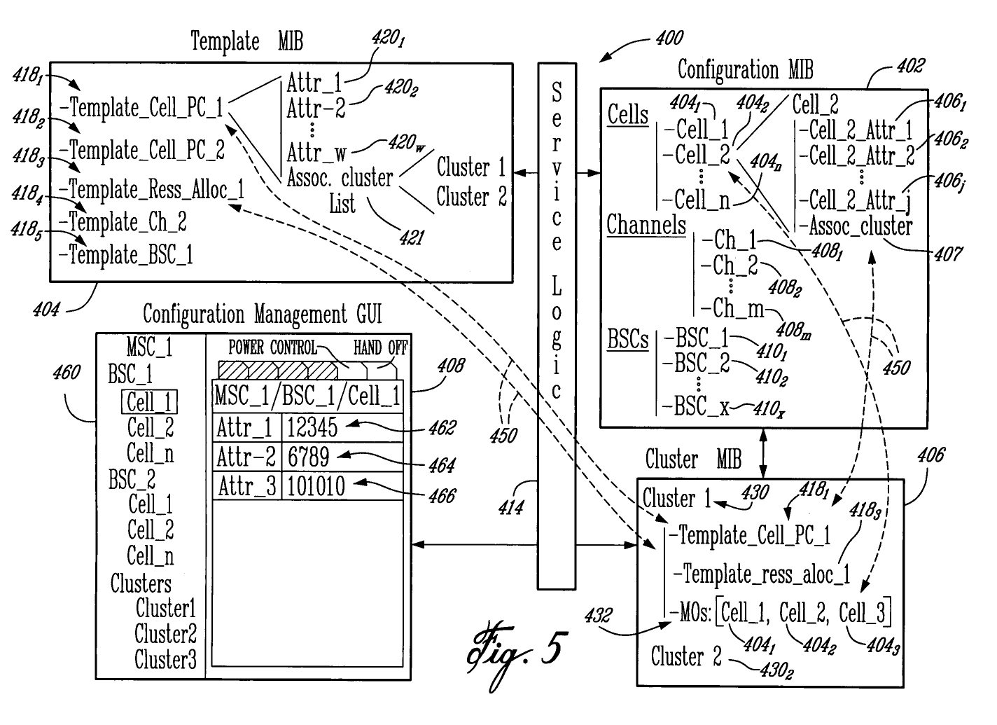

Reference is now made to FIG. 4, which is a high-level exemplary representation of a configuration management system 400 implementing the preferred embodiment of the present invention. Shown in FIG. 4 is first, a configuration Management Information Base (MIB) 402 responsible for storing a plurality of management object instances representative of network elements of a managed network (not shown). For example, the managed network may be a Public Land Mobile Network (PLMN) comprising radio base stations that define a plurality of cells, transceivers, mobile switching centers, home location registers, service control points, packet data nodes, as well as other types of components, etc. Each such network elements may have their virtual representations under the form of management object instances stored in the configuration MIB 402, which allows network administrators to supervise the network's status and performance by overseeing the management object instances and to propagate configuration changes toward the network elements by editing their corresponding management object instances.

Further comprised in the configuration management system 400 is a template MIB 404 that stores one or more configuration templates that comprise configuration attribute values applicable to either one or more management objects, or to clusters of management objects. The configuration templates stored in the template MIB 404 may be classified by types of templates, i.e. for example configuration templates that relate to radio cells, configuration templates that relate to base station controllers, configuration templates that relate to MSC components of a certain type, etc.

Finally, the configuration management system 400 also comprises a cluster MIB 406 including one or more management object clusters. Such clusters are groups of management objects that typically have the same type. For example, a management object cluster may comprise a plurality of cell-type management objects that share a same group of configuration attribute values. For this reason, such a cluster comprises first, an identification of a plurality of management object instances of the configuration MIB 402, and second, an identification of one or more configuration templates of the templates MIB 404, which attribute values are transferred to the plurality of management objects.

In addition, shown in FIG. 4 are two (2) exemplary configuration management control units 408 and 410 comprising Graphical User Interfaces (GUI) connected to the configuration MIB 402, to the template MIB 404 and to the cluster MIB 406, which allow network administrators to supervise and edit the status of management objects, templates and clusters. Service logic 414, which in the preferred variant of the invention may comprise computer-operated software programs and/or hardware modules, acts to perform the information transfer between the MIBs 402, 404, and 406 in a manner defined by the present invention and that is yet to be described.

Reference is now made to FIG. 5, which is a high-level block diagram of the configuration management system 400 according to the preferred embodiment of the present invention. First, the configuration management system 400 comprises the configuration MIB 402 responsible for storing the management object instances representative of network elements of the monitored network. For example, the configuration MIB 402 may comprise a series of cell-type management objects 404, wherein each such management object comprises a series of configuration attributes that define the characteristics of the MO, and by consequence of its associated NE, such as for example the configuration attributes 406 for the management object 404₂, including also an attribute 407, which is a reference to, or a list comprising a reference to one or more clusters of management objects to which the management object 404₂ belongs. The configuration MIB 402 may further comprise management objects of other types, such as for example but not limited to radio base station channels 408, and Base Station Controllers (BSC) 410, each such management object having its own lists of configuration attributes (not shown for simplicity purposes). During normal operation of the configuration management system, a network administrator may supervise the operation of the monitored network by supervising the status of the management objects the configuration MIB 402.

Also shown in FIG. 5 is the template MIB 404 that comprises configuration templates 418, each such template including a series of configuration attributes values to be applied to management objects. For example, the configuration template “template_cell_PC_1” 418₁ is a cell-type configuration template, which configuration attributes relate to the cell's power control (PC) and which comprises configuration attributes values 420, including an indication, or list, 421 of one or more associated clusters which management objects are to inherit attribute values from the template 418₁.

Further shown in FIG. 5 is the cluster MIB 406, which comprises one or more clusters 430, wherein each such cluster includes a group of management object instances that share the same configuration attribute values inherited from one or more configuration templates. For example, cluster 1 430₁, is shown as comprising a list 432 of three different management objects: cell_1 404₁, cell_2 404₂, and cell_3 404₃, which are all comprised in the configuration MIB 402. The cluster 1 430₁ further comprises a reference to two configuration templates, i.e. to “template_cell_PC_1” ⁴¹⁸, and “template_ress_aloc_1” 418₃, which are used to provide configuration attribute values to the management objects of the lists 432. Therefore, the three management objects that appear in the list 432 inherit configuration attribute values from both the template_cell_PC_1” 418₁, and from the “template_ress_aloc_1” 418₃. For example, because the management object cell_1 404₁ is part of the cluster 1 430₁, it inherits from “template_cell_PC_1” 418₁ attribute values related to the power control, while it also inherits from “template_ress_aloc_1” 418₃ attribute values related to resources allocation (e.g. frequencies allocation) in the radio cell.

According to the preferred embodiment of the present invention, this configuration attributes values inheritance not only happens upon creation of a new cluster such as the cluster 1 430₁, but also upon the editing of either an existing cluster, i.e. upon the introduction of either one or more new configuration templates into the cluster, or of one or more additional management objects, and also upon the edition of the configuration attribute values of any template included in the cluster. For example, when creating a new cluster in the cluster MIB 406, a network administrator may select one or more management objects and at least one template, and the configuration attribute values of the at least one template are transferred by service logic 414 to each one of the selected management objects. In addition, when editing an existing cluster, the network administrator may include an additional template into the cluster, so that the configuration attribute values of the added template are propagated to the management object(s) of the cluster.

Thus, according to the preferred embodiment of the present invention, a persistent relationship is created between a management object cluster, one or more management object instances that are grouped in the cluster, and one or more configuration templates listed in the cluster. This relationship 450 is shown in FIG. 5 in dotted arrows for the cluster 1 430₁, and is preferably bi-directional, i.e. each item is related to the other one as follows:
the cluster 1 430₁, comprises the list 432 of its management objects, which refers to the management objects 404₁, 404₂, and 404₃ of the configuration MIB 402. In turn, these management objects stored in the configuration MIB 402 also have a reference to the cluster they belong to, i.e. for example to cluster 1 430₁, via their respective attribute values, such as for example the shown attributes value 407 of the management object cell_2 404₂ of the configuration MIB 402, which reference points to the cluster 1 430₁.
the cluster 1 430₁ further comprises references to the templates 418₁ and 418₃ from the templates MIB 404, but these templates also comprise a reference to the cluster 1 430₁, such as for example in the illustrated attribute value 421 of the template 418₁ of the template MIB 404.

The fact that a persistent bi-directional relationship exists, first between the clusters and the management objects, and second, between the clusters and the templates allows for several advantages. First, when the cluster is updated by the inclusion of a new template, because the cluster maintains a list 432 of its management objects, the attribute values of the new templates can be automatically or semi-automatically propagated the management objects identified in the cluster. Second, when the management objects from the configuration MIB 402 is updated by a network administrator, and a new cluster is added as a new configuration attributes to the given management object, the attribute values of the configuration templates related to that cluster can again be automatically or semi-automatically propagated to the selected management objects. Third, when a template from the template MIB 404 is updated by the addition of a new cluster in its configuration attributes, the management objects of that cluster are automatically or semi-automatically updated with the attribute values comprised in that template.

Also shown in FIG. 5 is a configuration management Graphical User Interface (GUI) 408 that may be used by a network administrator in order to create or update management objects, template instances, and clusters. The configuration management GUI 408 may comprise a GUI portion 460 that displays a topology of the managed network comprising representations of the management objects of the configuration MIB 402, as well as a list of clusters from the cluster MIB 406, and the templates from the template MIB 404. The network administrator may select any entity, i.e. any management objects, cluster, or template from the GUI portion 460 in order to view and edit its attributes. In the exemplary view shown in FIG. 5, the configuration management GUI displays the attribute values 462, 464, and 466 of the management object “cell_1” 404₁.

Finally, shown in FIG. 5 is service logic 414 that is connected to the configuration MIB 402, to the templates MIB 404, to the cluster MIB 406, as well as to the configuration management GUI 408. The service logic 408 acts responsive to user instructions provided through the configuration management GUI 408 to transfer information among the MIBs 402, 404, and 406, during the creation of new clusters, during the edition of existing clusters, or during the edition of templates or management objects.

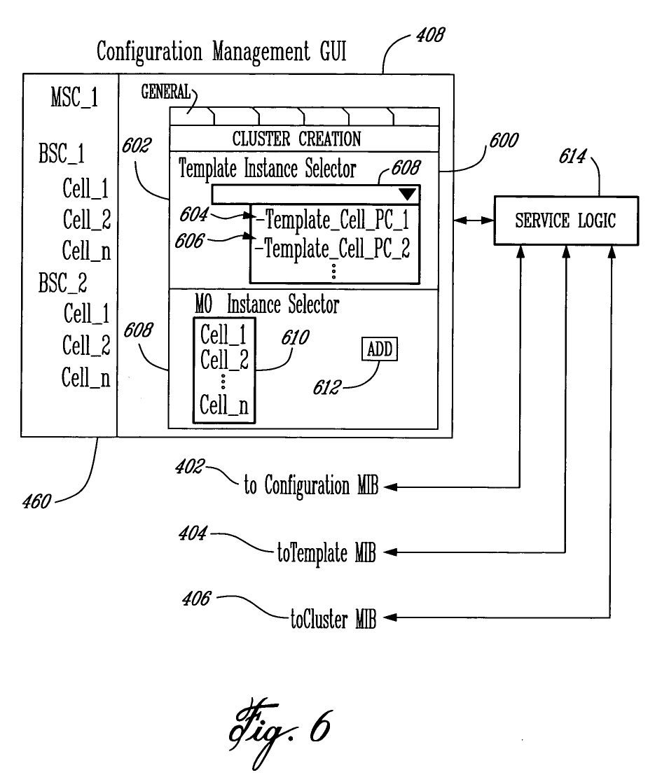

FIG. 6 is another exemplary representation of the configuration management GUI 408 according to the preferred embodiment of the present invention. Shown in FIG. 6, is a general tab portion 600 of the GUI 408 that allows a network administrator to create a new cluster of management objects. A cluster creation portion 600 of the GUI 460 described hereinbefore comprises a template instance selector 602 that allows a network administrator to select one or more existing configuration templates, such as for example the templates 604 and 606, which are to be added to the new cluster and that may be presented to the administrator (to the user of GUI 408) using a drop-down list 608. Further, the cluster creation portion 600 comprises a management object instance selector 608 that allows the network administrator to select one or more management objects from a list 610 that preferably comprises all management objects stored in the configuration MIB 402. Again, the lists of management objects may take the form of a drop-down list, or alternatively of a scroll-down list, or even be represented as a management objects topology tree, wherein the network administrator can select one or more management objects from the list or the tree, and then press an “ADD” button 612 to insert the selected management object into the cluster. Responsive to the selection of the templates and of the management objects using the GUI portion 600, service logic 614 connected to the configuration management GUI acts to create the persistent relationship, also called herein persistent link, between in the selected management objects, the selected templates, and the new cluster, i.e. first, to transfer the configuration attribute values of the selected template(s) to the selected management objects by updating/editing the management objects in the configuration MIB 402 including also the reference to the new cluster identity in their attributes, second, to update the selected template instances attribute values within the template MIB 404 by inserting a reference to the new cluster, and third, to create the cluster instance in the cluster MIB 406, which comprises reference to the selected templates as well as to the selected management objects.

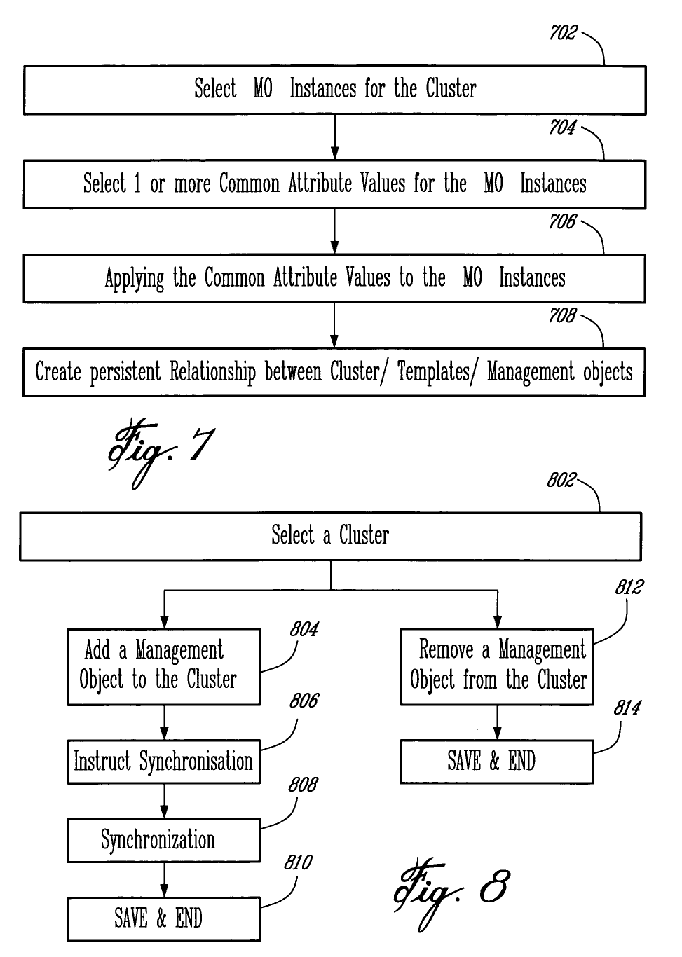

FIG. 7 is an exemplary flowchart diagram representative of a method for creating a management object cluster according to the preferred embodiment of the present invention. In FIG. 7, the method starts with action 702, wherein one or more management object instances are selected for becoming part of the new cluster. In action 704, there is selected one or more attribute values to be applied to (transferred to) the previously selected management object instances. The attribute values may come from one or more configuration templates of the templates MIB 404 as described hereinbefore. Further, in action 706, service logic connected to the configuration GUI 408 and to the MIBs 402, 404, and 406 acts to transfer the attribute values from the selected template(s) of the templates MIB 404 to the selected management object instances in the configuration MIB 402. Finally, in action 708, a persistent relationship, or link, is created by the service logic between the cluster, the selected template(s), and the selected management objects in the manner that has been described previously with reference to FIGS. 5 and 6.

FIG. 8 is another exemplary flowchart diagram representative of a method for updating a management object cluster according to the preferred embodiment of the present invention, wherein one or more management objects are either added or removed from the cluster. In action 802, the network administrator may select the cluster to be edited and, in action 804 one or more management object instances may be added to the cluster, or removed from the cluster.

When in action 804 one or more management objects are added into the cluster, new references to the identity of the added management objects are inserted into the cluster's list 432 of management objects that belong to the cluster, which is better shown in FIG. 5 in the cluster MIB 406. Once the new management object(s) is/are added to the cluster, the network administrator may instruct in optional action 806 the synchronization of the configuration MIB 402 with the cluster MIB 406 and with the templates MIB 404. Responsive to the administrator's instruction of step 806, or alternatively in an automated manner that bypasses the action 806, in action 808 service logic connected to the configuration GUI 408 acts to identify in the edited cluster the templates associated with the cluster, and to propagate the configuration attribute values of those templates from the templates MIB 404 to the newly added management object(s) in the configuration MIB 402. Finally, in action 810, the changes made are saved, i.e. the addition of the new management object(s) is saved in the edited cluster in the cluster MIB 406, and so are saved the new attribute values provided to the new management object(s) in the configuration template 402.

When, in action 812, one or more management objects are rather removed from the cluster that is edited, the changes made are saved in the cluster MIB 406 in action 814, and the method ends.

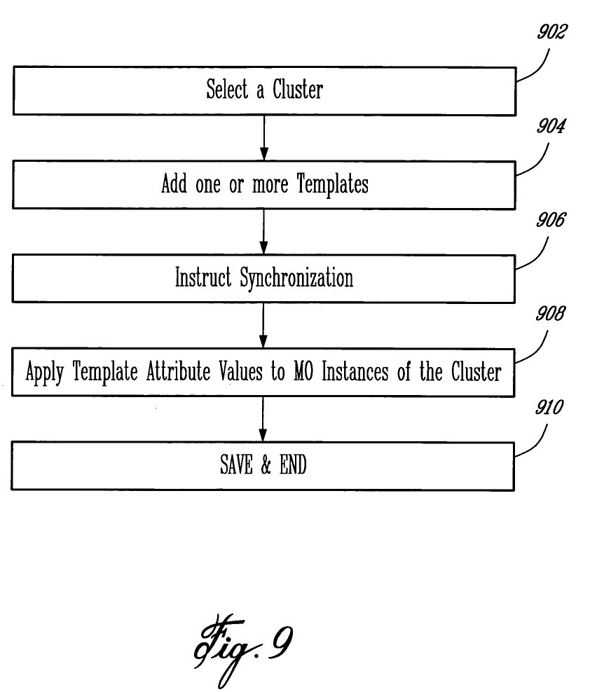

FIG. 9 is yet another exemplary flowchart diagram representative of another method for updating a management object cluster according to the preferred embodiment of the present invention, wherein one or more additional configuration templates are added to the cluster. In action 902, the network administrator may select a cluster to be edited, such as for example by using the configuration management GUI 408. In action 904, the network administrator may add one or more configuration templates to the cluster. In the optional action 906, the network administrator may instruct or trigger the synchronization between the templates MIB 404 and the configuration MIB 402. Responsive to the instruction of the synchronization, in action 908, the attribute values of the one or more templates selected in action 904 are transferred to the management object instances that belong to the cluster. Service logic associated with the configuration GUI 408 may act to identify the additional templates introduced to the cluster and based on the identity of the templates, retrieve from the templates MIB 404 the attribute values related to these templates, and transfer them to the management objects of the configuration MIB 402, which are listed in the cluster's list. Finally, in action 910, the changes made to the management object instances of the configuration MIB 402, as well as to the edited cluster of the cluster MIB 406, are saved and the method ends.

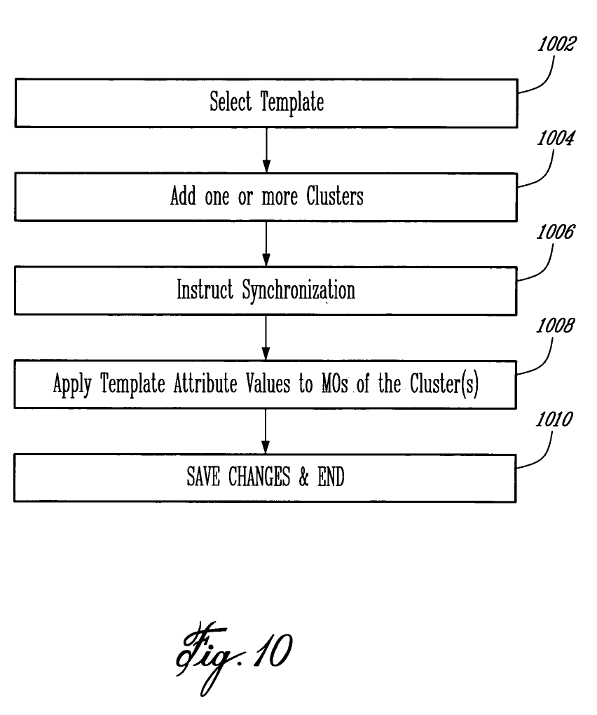

FIG. 10 is yet another exemplary flowchart diagram representative of a method for updating a configuration template according to the preferred embodiment of the present invention, wherein the changes made to a template of the templates MIB 404 are propagated to management objects associated with one or more clusters from the clusters MIB 406 linked to that template. In action 1002, a network administrator first selects a template from the templates MIB 404 that is to be updated, using for example the configuration management GUI 408. In action, 1004, the administrator adds one or more clusters to the template attributes, which clusters may be selected from a list of existing clusters of the templates MIB 404. Further, in the optional action 1006, the network administrator may instruct the synchronization of the template MIB 404 with the configuration MIB 402. Responsive to action 1006, or in an automated manner that bypasses the action 1006, in action 1008, the templates attributes values are transferred to the management objects associates with the cluster(s) that has/have been newly added to the template. Service logic associated with the configuration GUI 408 may act to retrieve from the edited template its attribute values, identify the additional cluster(s) introduced to the edited template and, based on the identity of the clusters, transfer the template's attribute values to the management objects of the configuration MIB 402 which are listed in the management objects list of the newly added cluster(s). Finally, in action 1010 the changes made to the management objects of the configuration MIB 402 as well as the changes made to the edited template of the templates MIB 404 are saved, and the method ends.

Therefore, with the present invention it becomes possible to create a persistent relationship between one or more management objects and one or more attribute values that are common to the management objects. These attribute values may be contained in one or more configuration templates, and the management objects are grouped in a cluster of management objects that share the same attribute values, i.e. the same configuration templates. The persistent relationship provided by the cluster between the templates and the management objects allows for a one-time definition of the persistent relationship, which reduces the subsequent edition tasks of network administrator. Since the relation between the management objects is defined, subsequent updates to the templates are propagated to the management objects of the cluster. Likewise, subsequent addition of management objects to the cluster engenders an inheritance of attribute values of the associated templates to the newly added objects.

Based upon the foregoing, it should now be apparent to those of ordinary skills in the art that the present invention provides an advantageous solution, which automatically or semi-automatically implements management objects updates. Although the system and method of the present invention have been described in particular reference to certain exemplary scenarios, it should be realized upon reference hereto that the innovative teachings contained herein are not necessarily limited thereto and may be implemented advantageously in various forms. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow. For example, while preferred embodiment of the invention have been described with reference to a service logic that acts to perform the various steps of the invention, it is understood that the service logic described hereinbefore may be distributed to one ore more of the configuration MIB 402, the templates MIB 404, and the cluster MIB 406, and may take various forms.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A cluster of management objects comprising:
a list of one or more management objects; and
a reference to one or more attribute values common to the plurality of management objects.

2. The cluster claimed in claim 1, wherein the reference comprises a reference to one or more configuration templates, each configuration template comprising at least one attribute value common to the plurality of management objects.

3. The cluster claimed in claim 2, wherein the one or more management objects comprise a plurality of management objects of a same type.

4. The cluster claimed in claim 2, wherein the cluster is stored in a cluster Management Information Base (MIB) of a configuration management system, the cluster MIB comprising a plurality of clusters of management objects.

5. The cluster claimed in claim 2, wherein the cluster maintains a relationship between the one or more management objects and the one or more configuration templates, wherein the one or more management objects inherit attribute values from the one or more configuration templates.

6. A configuration management system comprising:
a configuration Management Information Base (MIB) comprising a plurality of management objects; and
a cluster MIB comprising one or more clusters of management objects;
wherein each cluster of management objects comprises a reference to one or more attribute values common to one or more management objects from the plurality of management objects.

7. The configuration management system of claim 6, wherein the reference comprised in each cluster includes a reference to one or more configuration templates, each configuration template comprising at least one attribute value common to management objects of each cluster.

8. The configuration management system of claim 7, wherein each cluster of the cluster MIB comprises a list of management objects that belong to the cluster.

9. The configuration management system of claim 7, further comprising:
a template MIB including the one or more configuration templates.

10. The configuration management system of claim 9, wherein each one of the one or more configuration templates comprises a cluster list including a reference to one or more clusters of management objects.

11. The configuration management system of claim 7, wherein at least one management object of the plurality of management objects comprises a reference to at least one associated cluster from the cluster MIB.

12. The configuration management system of claim 9, further comprising a configuration management Graphical User Interface (GUI) for allowing user edition of the one or more clusters of management objects of the clusters MIB.

13. The configuration management system of claim 12, further comprising service logic connected to the management object MIB, to the cluster MIB, to the templates MIB, and to the configuration management GUI, wherein responsive to a user edition made through the configuration GUI that adds a new configuration template to a cluster of the one or more clusters of management objects, the service logic acts to transfer configuration attributes values of the new configuration template from the template MIB to management objects of the configuration MIB associated with the cluster.

14. The configuration management system of claim 12, further comprising service logic connected to the management object MIB, to the cluster MIB, to the templates MIB, and to the configuration management GUI, wherein responsive to a user edition made through the configuration GUI that adds a new management object to a cluster of the one or more clusters of management objects, the service logic acts to transfer configuration attributes values from at least one configuration template associated with the cluster to the new management object in the configuration MIB.

15. The configuration management system of claim 12, further comprising service logic connected to the management object MIB, to the cluster MIB, to the templates MIB, and to the configuration management GUI, wherein responsive to a user edition made through the configuration GUI that adds a reference to a new cluster of management objects to a configuration template of the templates MIB, the service logic acts to transfer configuration attributes values of the configuration template from the templates MIB to management objects associates with the cluster in the configuration MIB.

16. The configuration management system of claim 6, wherein each cluster of management objects is created by selecting one or more management objects from the plurality of management objects of the configuration MIB, and one or more attribute values common to one or more management objects.

17. A method for creating a cluster of management objects, the method comprising the steps of:
a. selecting one or more management objects;
b. selecting one or more configuration attribute values for the one or more management objects;
c. applying the one or more attribute values to the one or more management objects; and
d. linking the cluster containing the one or more management objects to the one or more configuration attributes values.

18. The method of claim 17, wherein:
step b. comprises selecting at least one configuration template that includes the one or more configuration attribute values;
step c. comprises applying the one or more attribute values from the at least one configuration template to the one or more management objects; and
step d. comprises linking the cluster containing the one or more management objects to the at least one configuration template.

19. The method of claim 18, further comprising the steps of:
e. adding a new management object to the cluster of one or more management objects; and
f. transferring the one or more attribute values from the at least one configuration template to the new management object.

20. The method of claim 18, further comprising the steps of:
e. adding a new configuration template to the cluster of one or more management objects; and
f. transferring at least one attribute value from the new configuration template to the one or more management objects of the cluster.
